(19) United States
(12) Patent Application Publication
(10) Pub. No.: US 2008/0237270 A1
(43) Pub. Date: Oct. 2, 2008

(54) Apparatus for Dispensing a Metered Quantity of Liquor

(75) Inventor: Craig Warren Garvie, Kwa Zulu Natal (ZA)

Correspondence Address: YOUNG & THOMPSON, 209 Madison Street, Suite 500, ALEXANDRIA, VA, 22314, US

(73) Assignee: DIGITOT INTERNATIONAL (PTY) LIMITED

(21) Appl. No.: 12/065,280

(22) PCT Filed: Aug. 29, 2005
(86) PCT No.: PCT/ZA2005/000129

§ 371 Date: Feb. 29, 2008

(51) Int. Cl. G01F 11/28

(52) U.S. Cl. 222/442; 222/453

(57) ABSTRACT

Apparatus for dispensing liquor has a thimble of pre-determined volume with a valve-controlled inlet (12) from a container for liquor and an outlet (10) for the liquor, the connection between the container including a shear (28) one side of which is for flow of liquor into the thimble and the other for flow of air from the thimble into the container as liquor flows into the thimble, a valve-controlled air vent (50) for entry of air into the thimble to replace the liquor flowing out of the thimble, and the valves (14, 16) for the inlet from the container and the outlet for liquor being mounted on a common shaft (20) and arranged for the outlet (10) to be closed when the inlet (12) is open and vice versa.

### TECHNICAL FIELD OF THE INVENTION

This invention relates to a tot (or shot, or nip or peg) measuring dispenser for liquor and other liquids.

In this specification the term “tot” is also intended to mean the American equivalent term “shot” or the term “nip” or “peg” as used in some other countries for a predetermined measured quantity of liquor.

### BACKGROUND ART

A conventional tot measuring device includes a thimble of predetermined volume (for example 25 ml which corresponds to a typical tot measure for liquors). The thimble includes an inlet for the liquor from a container and an outlet therefrom, both of which are controlled by suitable valve means. These valve means may be operated by electromagnetic, electro-optical or mechanical means. In the latter case the thimble may be moved from a first position in which it is full, to a second limiting position in which the full contents of the thimble are discharged. This movement may be actuated by the rim of a drinking tumbler so that the tot enters the tumbler ready for dilution with water or mixer. The thimble then moves to its first position, during which it is refilled with liquor for the next discharge.

As there is a tight fit between the inlet of the thimble and the container, the liquor will only fill the thimble if the air therein is released above the level of the liquor in the container. An air vent has been used for this purpose which extends to a position above the level of liquor therein and to atmosphere. The level of liquor in the air vent corresponds with the level of the liquor in the container so that when the thimble is discharged, the volume of liquor in the air vent is drawn into the outward flow, thus resulting in a total volume of tot in excess of the predetermined volume. As the level of the liquor in the container drops so does the level of liquor in the air vent with the result that the actual volume of the tot discharged becomes smaller as the content of the container decreases. This may be a problem in some establishments and is also, in some countries, against the law as the total tot volume may be in excess of a preordained volume.

To avoid this disadvantage it has been proposed (see South African Patent Application 2004/4411) to provide a vent from the thimble to atmosphere and the container having a second bent leading from a low level in the container to atmosphere. The lower end of the second vent determines the level of the liquor in the first vent, whatever the level of the liquor is in the container. Thus an exact measure is always obtained.

A problem can arise in bars, or other rooms in which the dispensing apparatus is located, when the business of the evening is closed and the air-conditioning system switched off. The ambient temperature rises and the temperature, and therefore the pressure of the air above the level of the liquor in the container, rises with the result that the level of liquor in the second vent rises and may even overflow with concomitant loss and mess.

It is an object of the invention to provide apparatus which avoids or at least greatly minimises this problem.

### DISCLOSURE OF THE INVENTION

According to the invention apparatus for dispensing liquor includes a container and a thimble of predetermined volume having a valve-controlled inlet from the container and an outlet for liquor, characterised in that
the connection between the thimble and the container includes a shear, one side of which is for flow of liquor into the thimble and the other for flow of air from the thimble into the container as liquor flows into the thimble;
a valve-controlled air vent for entry of air into the thimble to replace the liquor flowing out of the thimble, and
the valves for the inlet from the container and the outlet for liquor being mounted on a common shaft and arranged for the outlet to be closed when the inlet is open and vice versa.

In one form of the invention the valve-controlled air vent is activatable from the shaft and may include an arm connected to the shaft, the arm serving to raise or lower the stem of the valve according to the direction or movement of the shaft. Thus, the air vent must be pen when the thimble is discharging liquor, and closed when the thimble is being filled.

The effective volume of the thimble, and thus the volume of liquor to be discharged may be determined by means of interchangeable floats of different volumes which are locatable in the thimble.

The shear is preferably located in a passageway from the container to the thimble and in a refinement of the invention the shear is offset from the centre of the passageway so that the passage for liquor is greater than that for air.

### BRIEF DESCRIPTION OF THE DRAWINGS

An embodiment of the invention is described below with reference to the accompanying drawings which are sectional side views of apparatus according to the invention.

### BEST MODE FOR CARRYING OUT THE INVENTION

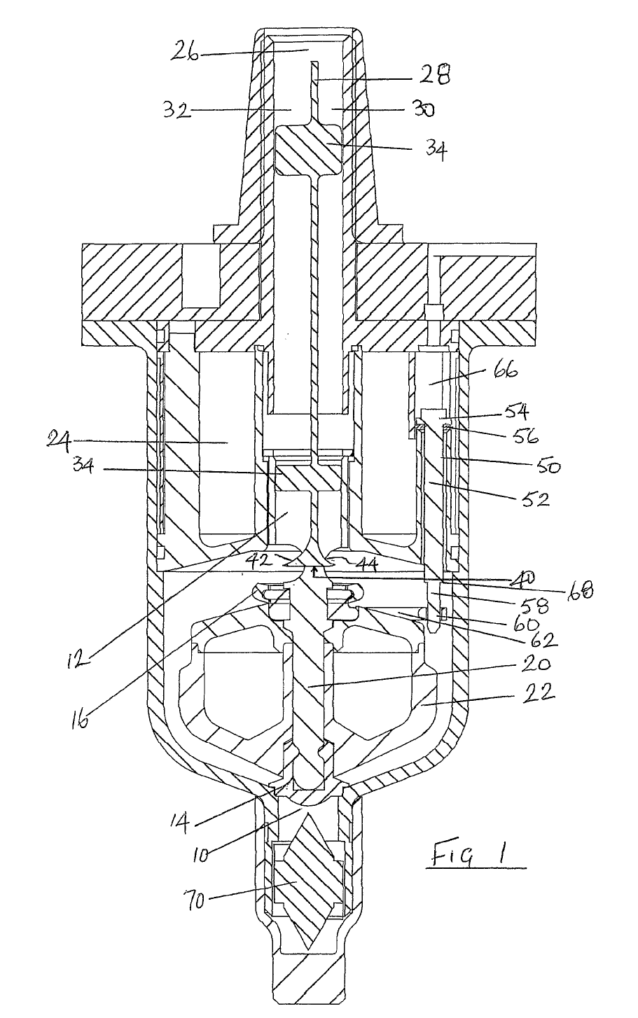

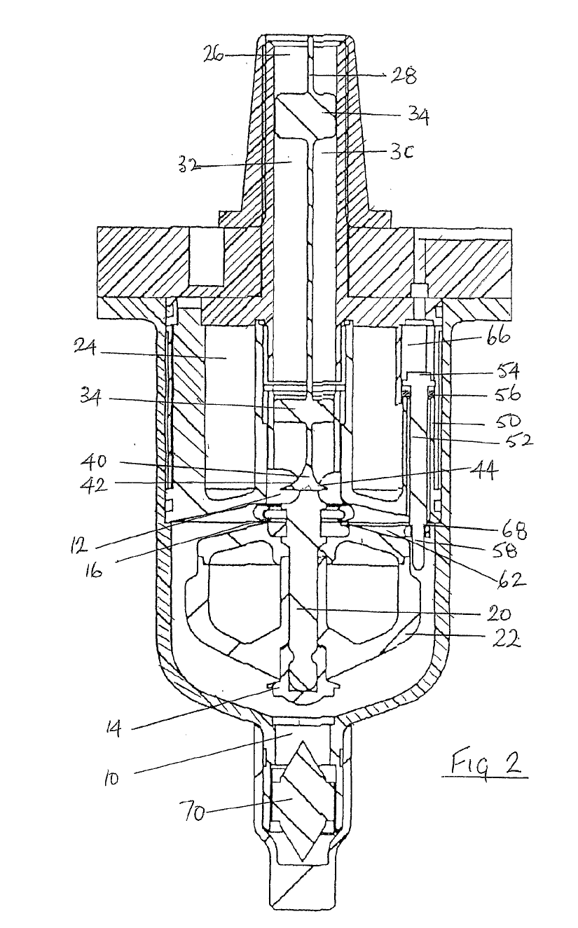

In FIG. 1 apparatus is shown in the position in which the outlet 10 for liquor is closed and the inlet 12 for liquor from a container (not shown) is open; while FIG. 2 shows the apparatus in the opposite mode-outlet open and inlet closed.

The corresponding valves 14, for the outlet and 16 for the inlet are carried on a common shaft 20 which also carries a float 22—which, as described above is of a volume calculated for a predetermined volume in the thimble of liquor to be dispensed.

Although the apparatus may be adapted to operate manually or electro-optically, it is preferred that the operation is by way of a solenoid 24.

The connection between the container and the thimble is a passageway 26 which includes a shear 28 located off-centre as shown, the smaller passage 30 being for air and the large 32 for liquor. Brackets 34 maintain the shear in the correct position.

A foot 40 of the shear includes curved zones 42 for smooth passage of liquor and air.

An air vent 50 is located to the side of the thimble and includes a rod 52 having a cap 54 which seats on a washer 56—see FIG. 1. The lower extremity of the rod has a narrow portion 58 which passes through an orifice 60 in an arm 62 which is directly attached to the shaft. The rod is biased to its closed position by a compression spring 66. In FIG. 1 the air vent is closed, but in FIG. 2 the movement of the shaft causes the arm to slide up the narrow portion of the rod until it engages the shoulder 68, thus causing the rod to be raised off the washer for air to be permitted to escape.

The outlet 10 of the thimble is provided with tamperproof means 70 such as a tamper nozzle, and may also be twisted to impart a swirling motion to the liquor on discharge.

1. Apparatus for dispensing liquor includes a container and a thimble of predetermined volume having a valve-controlled inlet from the container and an outlet for liquor, characterised in that
the connection between the thimble and the container includes a shear, one side of which is for flow of liquor into the thimble and the other for flow of air from the thimble into the container as liquor flows into the thimble;
a valve-controlled air vent for entry of air into the thimble to replace the liquor flowing out of the thimble, and
the valves for the inlet from the container and the outlet for liquor being mounted on a common shaft and arranged for the outlet to be closed when the inlet is open and wee versa.

2. Apparatus for dispensing liquor according to claim 1 characterised in that the valve controlled air vent is activatable from the shaft and may include an arm connected to the shaft, the arm serving to raise or lower the stem of the valve according to the direction or movement of the shaft.

3. Apparatus for dispensing liquor according to claim 1 is characterised in that the effective volume of the thimble, and thus the volume of liquor to be discharged may be determined by means of interchangeable floats of different volumes which are locatable in the thimble.

4. Apparatus for dispensing liquor according to claim 1 characterised in that the shear is located in a passageway from the container to thimble and in a refinement of the invention the shear is offset from the centre of the passageway so that the passage for liquor is greater than that for air.

5. Apparatus for dispensing liquor according to claim 1 characterised in that the shear has a foot with curved zones corresponding with the liquor and air passages.

6. Apparatus for dispensing liquor according to claim 2 characterised in that the effective volume of the thimble and thus the volume of liquor to be discharged may be determined by means of interchangeable floats of different volumes which are locatable in the thimble.

7. Apparatus for dispensing liquor according to claim 2 characterised in that the shear is located in a passageway from the container to the thimble and in a refinement of the invention the shear is offset from the centre of the passageway so that the passage for liquor is greater than that for air.

8. Apparatus for dispensing liquor according to claim 3 charactertised in that the shear is located in a passageway from the container to the thimble and in a refinement of the invention the shear is offset from the centre of the passageway so that the passage for liquor is greater than that for air.

9. Apparatus for dispensing liquor according to claim 2 characterised in that the shear has a foot with curved zones corresponding with the liquor and air passages.

10. Apparatus for dispensing liquor according to claim 3 characterised in that the shear has a foot with curved zones corresponding with the liquor and air passages.

11. Apparatus for dispensing liquor according to claim 4 characterised in that the shear has a foot with curved zones corresponding with the liquor and air passages.
